(19) United States
(12) Patent Application Publication
(10) Pub. No.: US 2003/0140734 A1
(43) Pub. Date: Jul. 31, 2003

(54) Magnetic roofing hammer

(76) Inventor: Christopher Tovar, Arcadia, CA (US)

Correspondence Address: Boniard I. Brown, 1500 West Covina Parkway, #113, West Covina, CA, 91790-2793, US

(21) Appl. No.: 10/353,594

(22) Filed: Jan. 29, 2003

Related U.S. Application Data
(60) Provisional application No. 60/353,027, filed on Jan. 30, 2002.

(51) Int. Cl. B25D 1/00

(52) U.S. Cl. 81/24

(57) ABSTRACT

A hammer head face has a relatively small magnet centered therein and forming a part of the hammer surface. With the hammer positioned in general proximity to a nail having a disk thereon, the nail is drawn to and centered on the hammer face for accurate driving of the nail without manual grasping thereof.

### RELATED APPLICATIONS

Reference is made to my Provisional Application No. 60/353,027, filed Jan. 30, 2002, entitled “Magnetic Roofing Hammer”.

### BACKGROUND

The present invention relates to an improved magnetic hammer having a strong magnet in the hammering surface of a hammer head, typically for use with roofing nails in the installing of tarpaper and securing shingles to roofs.

Roofing nails having plastic disks or crowns thereabout under the heads thereof are widely used because of their better retention of tarpaper on a roof, much better than a simple nail with a relatively small head, and they retain the tarpaper for a much longer time, because a disk provides more area for tarpaper retention.

Such nails with disks are sometimes referred to as “retainer crowns”. The crown on such a nail better holds roofing tarpaper on a roof. The disk covers a larger area to provide better securement with less stress concentration in the tarpaper.

In the prior art, a roofing nail without a disk or “crown” had to be held by one hand while the nail was struck by the hammer. This often resulted in injuries to fingers and hands, with attendant medical expense, loss of work, and sometimes permanent injury.

The prior art includes U.S. Pat. No. 2,671,483 to Clark and U.S. Pat. No. 4,291,736 to Robertson. The device of Robertson is relatively complicated, having a relatively large magnet in a cylindrical chamber in the hammer head. A retainer member is secured by a threaded member or screw. The magnet outer face comprises most of the hammer face.

The Clark magnetic hammer has an elongated magnet disposed in the hammer head portion, a steel member extending from the outer end of the magnet and through a threaded steel end member forming a portion of the hammer face. The Clark device has multiple parts and a magnet does not extend to the hammer face to exert more attraction force in contrast with Applicant's claimed device.

With plastic disks disposed about the shafts of nails, Applicant's small strong magnet, disposed in the hammer face, attracts a nail with a plastic disk thereon, when placed in proximity of such nail, as on a floor or roof, thus to automatically center the nail and disk on the hammer head, without necessity for fingers grasping the nail during the hammering process.

### BRIEF DESCRIPTION OF THE DRAWINGS

FIG. 1 is a perspective view of a magnetic roofing hammer according to the invention;

FIG. 2 is a perspective view of the hammer of FIG. 1 with a roofing nail, with plastic disk thereon, held centered on the face of the hammer head;

FIGS. 3 and 6 are perspective views illustrating the hammer of FIG. 1 in relation to roofing nails with plastic disks thereon positioned to be drawn magnetically to the face of the hammer head;

FIG. 4 is a sectional view taken at line 4-4 in FIG. 2; and

FIG. 5 is a view of the hammering face of the hammer of FIGS. 1 and 2, with a nail with disk thereon being drawn to the center of the hammering face.

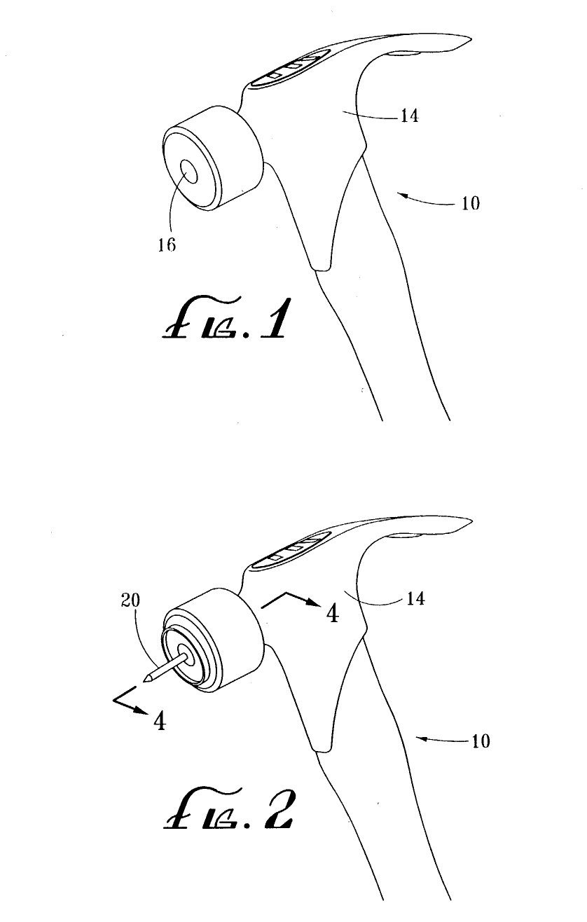

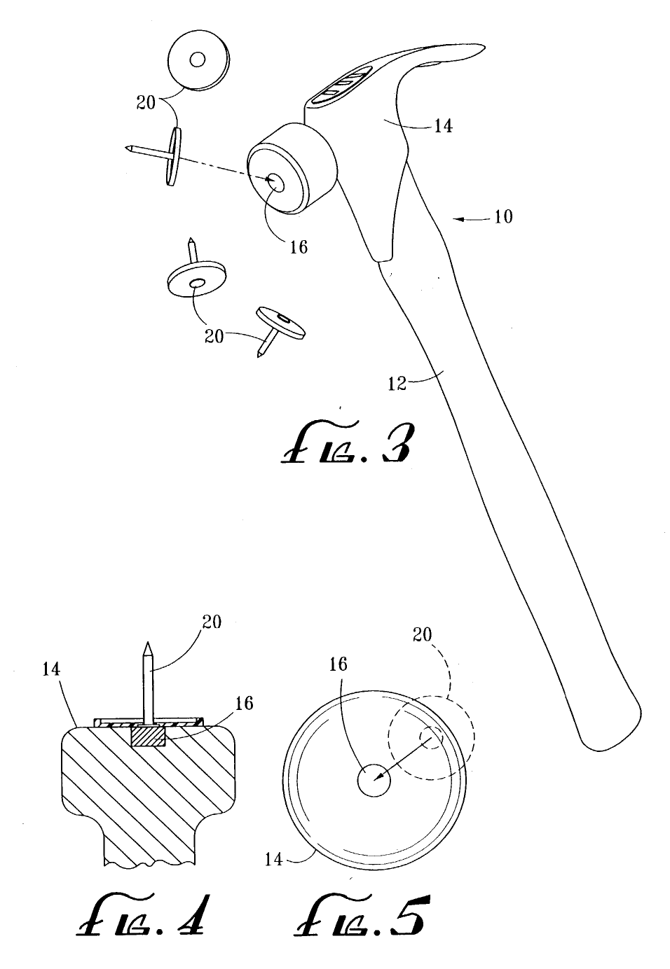

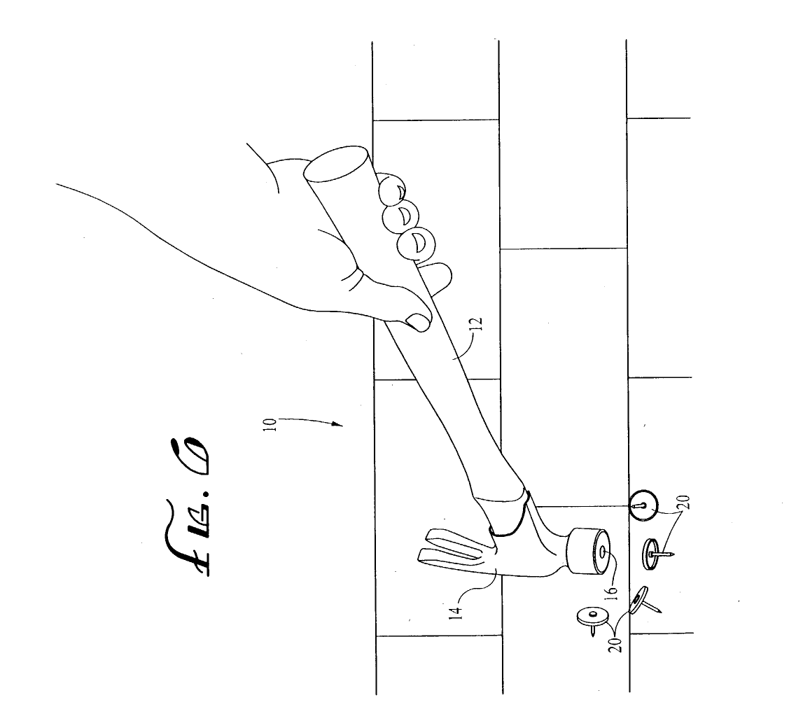

### DESCRIPTION OF THE PREFERRED EMBODIMENT

Referring to the drawings, a magnetic hammer 10 of the present invention has a handle 12 to which a hammer body or hammer head 14 is secured. A cylindrical magnetic insert 16 is force-fitted or press-fitted into a cylindrical cavity 18 defined in the face of the hammer head. The magnet insert may preferably be ¼ inch in diameter, while the cavity is about 0.001 inch smaller in diameter than the magnet diameter. The magnet is typically pressed in utilizing a 40 ton press. The magnet may preferably be formed of alnico, a permanent magnet alloy formed of iron, nickel, aluminum and one or more of cobalt, copper and titanium. This provides an extremely strong magnet with a holding force of about 15-20 ounces.

The hammer is typically utilized with a roofing nail having a plastic disk or crown 20 thereon, such disks being well known in the art. With a plurality of such nails disposed on a roofing surface, the positioning of the hammer head striking face in proximity or in contact with a nail, the nail is drawn onto the striking face of the hammer and is centered thereon by the force of the magnet, as indicated in the drawings.

The plastic disks provide improved securement of tarpaper on a wooden roof because each plastic crown or disk covers a much larger area than a typical roofing nail head. With the nail thus centered on the hammering surface of the hammer, a nail is pounded in. After the first blow, the nail is typically fully driven in by another blow of the hammer or at most two blows.

With the hammer of the invention, a roofer can extend one arm holding a hammer with a nail magnetically secured thereto, into an enlarged nailing radius, and greatly increases the effective area the roofer can cover without himself moving to a new location. The roofer is enabled to reach much farther by extending his arm, and cover a greater area. The rate at which the roofer can apply shingles to tarpaper and a roof is substantially increased. A roofing worker's productivity is typically more than doubled. Much increased safety and prevention of injuries to fingers and hands are provided, because the person does not have to hold a nail with his fingers at the time of impacting the nails with a hammer.

It will be understood that various changes and modifications may be made from the preferred embodiment discussed above without departing from the scope of the present invention, which is established by the following claims and equivalents thereof.

The inventor claims:

1. A magnetic hammer comprising:
a handle,
a hammer head mounted on the handle and having a generally flat hammer face,
said hammer head defining a socket therein,
a magnet force-fitted in said socket, and
said magnet having an outer surface substantially flush with and forming a part of the hammer head face.

2. A magnetic hammer according to claim 1 wherein said magnet is centered in said hammer face.

3. A magnetic hammer according to claim 1 wherein said magnet has a thickness of about ¼ inch.

4. A magnetic hammer according to claim 1 wherein said magnet has a diameter of about ¼ inch.

5. A magnetic hammer according to claim 1 wherein said magnetic force with the hammer face in proximity to a nail on a surface draws the nail onto said hammer face and centers it thereon.

6. A magnetic hammer according to claim 1 wherein said magnet has a diameter less than 0.008 inch larger tha n the diameter of said socket. 10.

7. A magnetic hammer comprising:
a handle,
a hammer head mounted on the handle and having a generally flat hammer face,
said hammer head having defined therein a socket,
a magnet force-fitted in said socket and having a magnetic holding force in a range of about 15-20 ounces, and
said magnet being centered on said hammer face.

8. A magnetic hammer according to claim 7 wherein an outer surface of the magnet is substantially flush with the hammer head face and forms a part thereof.

9. A magnetic hammer according to claim 7 wherein said magnet has a diameter of about ¼ inch.

10. A magnetic hammer according to claim 7 wherein said magnet has a thickness of about ¼ inch.

11. A magnetic hammer according to claim 7 wherein said magnet is force-fitted into said socket by application of about 10,000 pounds force.

12. A magnetic hammer according to claim 7 wherein said magnet has a diameter less than 0.008 inch larger than the diameter of said socket.

13. A magnetic hammer according to claim 7 wherein said magnetic force with the hammer face in proximity to a nail on a surface draws the nail onto said hammer face and centers it thereon.

14. A magnetic hammer comprising:
a handle,
a hammer head mounted on the handle and having a substantially flat hammer face,
said hammer head defining a socket about ¼″ in diameter,
a generally cylindrical magnet force-fitted in said socket,
an outer surface of the magnet being substantially flush with said flat hammer face, and
said magnet having a magnetic holding force of about 15-20 ounces,
whereby upon positioning the hammer face in proximity to a nail disposed on a surface the nail is drawn by magnetic force onto the hammer face and generally centered thereon to be driven into an object without manually grasping the nail.

15. A magnetic hammer according to claim 14 wherein an outer surface of the magnet is substantially flush with the hammer head face and forms a part thereof.

16. A magnetic hammer according to claim 14 wherein said magnet has a thickness of about ¼ inch.

17. A magnetic hammer according to claim 14 wherein said magnet is force-fitted into said socket by application of about 10,000 pounds force.

18. A magnetic hammer according to claim 14 wherein said nail is one of a plurality of roofing nails disposed on a roof to be drawn onto the hammer face in succession.

19. A magnetic hammer according to claim 14 wherein said magnet has a diameter less than 0.008 inch larger than the diameter of said socket.

20. A magnetic hammer according to claim 14 wherein said nail and a disk thereon-are substantially centered on said hammer face.

21. A magnetic hammer according to claim 14 wherein said nail is a roofing nail having a disk thereabout.
